(19) United States
(12) Patent Application Publication
(10) Pub. No.: US 2026/0310034 A1
(43) Pub. Date: Oct. 8, 2026

(54) WINDOW ASSEMBLY FOR SECTIONAL VARIABLE LIGHT TRANSMISSION IN AN AERIAL VEHICLE

(71) Applicant: Airbus Operations GmbH, Hamburg (DE)

(72) Inventor: Annette Greggersen, Hamburg (DE)

(73) Assignee: Airbus Operations GmbH, Hamburg (DE)

(21) Appl. No.: 19/631,367

(22) Filed: Mar. 27, 2026

(30) Foreign Application Priority Data
Apr. 8, 2025 (DE) 102025113855.9

(51) Int. Cl. G02F 1/163; B64C 1/14

(52) U.S. Cl. CPC G02F 1/163; B64C 1/1484

(57) ABSTRACT

A window assembly for sectional variable light transmission in an aerial vehicle includes a transmissivity adjustment layer divided into multiple adjacent sections arranged along an alignment axis. Each section can independently adjust its light transmissivity in response to a control signal. A controller is configured to sequentially apply individual control signals to each section, enabling a stepwise adjustment of light transmissivity along the alignment axis. This technology allows for precise and dynamic control of light entering the vehicle, enhancing passenger comfort and energy efficiency.

### TECHNICAL FIELD

The present disclosure relates to a window assembly for a vehicle, specifically a window with electronically controllable variable light transmissivity for an aerial vehicle.

### BACKGROUND

Airplane windows may feature a movable shade that can be adjusted to allow or block light, enhancing the vehicle's or aircraft's interior comfort and visibility. In some cases, the window shade may be adjusted at different heights to modify the amount of light entering the vehicle. These shades can be mechanical devices and may require regular maintenance to ensure their proper functioning. Additionally, an aircraft may have multiple windows, and window shades may negatively contribute to the overall weight of the aircraft. Furthermore, mechanical shades may lack the function for a centralized control requiring contribution from passengers and/or the crew to set all shades to a specific setting.

### SUMMARY

It is therefore an object of the present disclosure to provide an efficient electronically shadable window.

The disclosure herein pertains to advanced electro-dimmable windows technology, by providing multiple dimmable window sections. Each segment, when activated, transitions to full dark, achieving the lowest light transmissivity. This segmentation allows for precise control over the window's light transmission properties.

The window segments can be operated in a sequential manner. For closing, the segments can be activated from top to bottom, progressively darkening the window. Conversely, for opening, the segments are activated from bottom to top, gradually lightening the window. This sequential activation provides a smooth transition between different states of transmissivity, respectively opacity.

To achieve a brighter appearance, the dimming technology can be integrated with an additional switchable technology layer, in particular in a white color. This combination may enhance the window's aesthetic and functional versatility, offering a visually appealing solution that can adapt to varying light conditions.

Furthermore, the segmented window may offer flexible operational modes. They can be used for segment-wise operation, where individual segments are activated sequentially for opening and closing. Alternatively, they can be used for full window dimming, where all segments are dimmed simultaneously to achieve uniform transmissivity across the entire window. Thus, significant advantages in terms of light control and aesthetic integration can be achieved. The ability to precisely manage light transmission enhances passenger comfort and reduces glare, while the integration of a white switchable technology layer can offer a brighter and more visually appealing appearance.

According to a first aspect the disclosure herein relates to a window assembly for sectional variable light transmission in an aerial vehicle. The window comprises a transmissivity adjustment layer sectioned into a plurality of layer sections. The layer sections are arranged adjacent to one another. Further the layer sections are arranged along an alignment axis.

Each layer section is operable to adjust a light transmissivity of the layer section according to a control signal.

The window assembly can comprise a control module (controller). The controller can be configured to sequentially apply an individual control signal to each layer section to generate a stepwise light transmissivity adjustment of the window along the alignment axis.

The window assembly can be used to provide windows without mechanical shades. The window assembly can relate to a single window comprising a stack of layers, comprising at least one transparent layer. The transmissivity adjustment layer can adjust the transmission level of light entering the vehicle through the window assembly, allowing for a darkened or dimmed state to minimize or block light. Sectioning the transmissivity adjustment layer allows a first set of sections to reduce or block incoming light and a second set of sections may remain in a state of higher transmissivity, preferably fully transparent, providing a partially transmissive state of the window assembly.

The window assembly can refer to a complete unit of a window. Thus, the window assembly may include a frame, glass, and/or any associated mechanisms or components according to its functions. In a minimal form the window assembly can be a composite structure comprising a set of layers, wherein at least one layer can be permanently transparent. Preferably the composite structure comprises at least one layer which can be adjusted in light transmissivity.

The window assembly can refer to an aircraft window, which is preferably designed to withstand high pressures, temperatures and/or large temperature fluctuations. Thereto, the composite structure can comprise multiple layers of glass and/or polymer materials providing strength and insulation.

Sectional variable light transmission can refer to a window divided into separately controllable sections and/or parts. The window can be divided into different segments. Each segment can have different properties or functionalities. Preferably, the sections can independently adjust their tint and/or opacity.

Variable light transmission can refer to the ability to change the amount of light passing through the window assembly.

By providing a sectionally variably transmissive window passenger comfort and safety aspects of the vehicle can be enhanced. Preferably, glare can be reduced, and the influx of heat and light can be efficiently managed within a vehicle compartment, specifically a vehicle passenger cabin.

The controller can be configured to apply an individual control signal to each layer section. Thereto, a stepwise light transmissivity adjustment of the window along the alignment axis can be generated by sequentially controlling the plurality of layer sections, such that adjacent layer sections are adjusted one after the other along the alignment axis.

The controller can be configured to control the transmissivity of light through multiple sections of a single window.

Each layer section can extend perpendicular to the alignment axis.

Adjacent layer sections can be delimited by a boundary section, preferably a straight boundary section. The boundary can be oriented perpendicular to the alignment axis.

The alignment axis can be a vertical orientation axis of the aerial vehicle, in particular a vertical axis of a passenger compartment.

In an embodiment the controller can be configured to apply a timed sequence of control signals to the transmissivity adjustment layer, wherein a delay is applied between control signals to adjacent layer sections.

The timed sequence can define a consecutive activation, respectively adjustment of layer sections. Preferably, in a row of layer sections, one after the other is adjusted according to the delay. Thereby, a dynamic shading effect similar to the function of a mechanical shade but with enhanced functionality can be created. In particular, adjusting the shading may be completely silent.

For example, a first section can receive a control signal and after a delay a second section adjacent to the first section can receive a corresponding further control signal. The timed sequence is not limited to adjacent sections. In a further example, a progressive transmissivity gradient can be initiated from any section and/or along any direction along the alignment axis. Preferably, the delay in activating in adjacent segments realizes a perceivable activation sequence of the sections in a direction along the alignment axis.

The timed sequence of control signals can ensure smooth transitions between different opacity levels, enhancing passenger comfort. Further, the individual control of the segments can allow for precise control over light transmission, enabling passengers to adjust the window to an individual preferred level of shading.

In a further embodiment, the controller can be configured to set the delay to a value below a response latency of the corresponding layer section to reach the light transmissivity value set by the control signal.

A response latency can be identical between segments. Thereto the transmissivity adjustment layer can have a homogenous response latency. For example, a first segment can be controlled to increase to the lowest light transmissivity. The first segment may gradually approach the state of lowest light transmissivity in material dependent time interval. The controller can be configured to control a second segment disposed adjacent to the first segment to also increase to the lowest light transmissivity after a set delay of initiating the transmissivity adjustment of the first segment. Thus, the transition of the first segment can be offset to the transition of the second segment. The controller can be configured to control the plurality of sections in a cascading fashion to provide a progressing transmissivity gradient, in particular in the direction of the alignment axis.

Each section can have an inhomogeneous areal latency based on the position of electrical contacts providing the control signal to the section. For example, a transmissivity change can be initiated at the electrical contacts and progress inward from the electrical contact points.

The transmissivity adjustment layer can be disposed a surface electrode, preferably between a set of surface electrodes. The surface electrode can be configured to provide the control signal the transmissivity adjustment layer. Preferably, each layer section can be disposed on a corresponding surface electrode section. The surface electrode can be configured to apply the control signal homogenously to the transmissivity adjustment layer. Thereby, a homogenous light transmissivity adjustment of the corresponding layer section can be realized.

In a further embodiment, the controller can be configured to set all layer sections to a state of maximal light transmissivity when a power loss to the controller occurs.

Preferably, the transmissivity adjustment layer, respectively each layer section, can be configured to turn completely transparent when no signal is applied. Thus, the transmissivity adjustment layer, respectively each layer section, can be configured to fail clear. Automatically adjusting to the highest transmissivity setting can maximize visibility, in particular during landing and take-off maneuvers. Thereby, compliance with safety regulations can be ensured.

The controller can be configured to automatically adjust to the lowest transmissivity setting to reduce heat influx and UV exposure, in particular in a storage position and/or parking position.

In a further embodiment, each layer section can have a constant width with respect to the alignment axis. A visible surface area of the window assembly can be fully covered by the plurality of layer sections.

Fully covering the visible surface area can achieve the advantage that the net light transmissivity of the window assembly can be fully controlled by the controlling the light transmissivity of each layer section of the plurality of layer sections. Preferably, the transmissivity adjustment layer is configured to appear black when set to low levels of light transmissivity. All layer sections can have the same width along the alignment axis with respect to each other.

A constant width of the layer sections and a constant delay can provide a consistent progression of a transmissivity adjustment.

In a further embodiment, the controller can be configured to continuously adjust the light transmissivity of a layer section by providing at least one of a constant control signal and a varying control signal to the corresponding layer section.

With a constant control signal, the transmissivity adjustment of the corresponding section may occur at a corresponding constant transmissivity adjustment rate. When a maximum constant control signal is applied, the transmissivity adjustment may only be limited by the latency of the material to change between different light transmissivity states. The transmissivity adjustment layer can be configured to continuously change its light transmissivity when a constant signal is applied.

Alternatively, with a varying control signal the speed of the transmissivity adjustment can be controlled to a predetermined value, i.e. a predetermined transmissivity adjustment rate or rate profile. Preferably, a chosen transmissivity gradient over time, respectively a transmissivity transition within a predetermined time interval, can be realized.

By controlling each section individually predetermined patterns of varying transmissivity can be realized. For example, adjusting transmissivity from a center section outward, from at least one edge section towards the opposite edge section, or alternating with sections of maximal transmissivity bordering sections of minimal transmissivity at a final state. The transmissivity can be periodically modulated to provide a varying brightness environment in the vehicle. For example, the controller can be configured to simulate a sunset or sunrise, and/or periodically provide a brightness stimulus to a passenger.

The controller can be configured to apply a varying control signal according to a predetermined final transmissivity state and the material latency such that a perceivability of a border between two adjacent layer sections is minimized. For example, the controller can be configured to minimize a contrast difference between two adjacent layer sections wherein each of the adjacent layer section is in the process of adjusting from an initial transmissivity state to a final transmissivity state.

In a further embodiment, the window assembly can comprise a switchable optical layer. The switchable optical layer can be sectioned into a plurality of secondary layer sections arranged adjacent to one another and/or arranged along the alignment axis. Each secondary layer section can be operable to switch between a first optical state and a second optical state according to a further control signal. Each secondary layer section can be transparent in the first optical state, and/or each secondary layer section can be at least partially opaque in the second optical state.

The switchable optical layer can have a lower material latency than the transmissivity adjustment layer. Thereto the switchable optical layer can transition faster between the first optical state and the second optical state. In particular, a state switch of the switchable optical layer can be perceivable as being instantaneous.

The switchable optical layer can be a second electrochromic layer, in particular having a different color in the second optical state that the transmissivity adjustment layer in lowered transmissivity states. Alternatively, the switchable optical layer can be a polymer dispersed liquid crystal (PDLC) that can be configured to switch between transparent and opaque states when voltage is applied.

Generally, the switchable optical layer can utilize any one of various scattering technologies, such as switchable scattering layers. The switchable optical layer can be configured to allow dynamic control of light scattering properties, enabling the layer to switch between different scattering states.

Alternatively, the switchable optical layer can be a suspended particle device (SPD), which comprises particles suspended in a polymer matrix to switch between transparent and opaque states. In a further example, the switchable optical layer can comprise polymer-stabilized cholesteric liquid crystals (PSCLC) that can be configured to switch between transparent and scattering states by reorienting liquid crystal molecules under an electric field. In contrast to the example of using an electrochromic layer which is dimmable rather than switchable as the transmissivity adjustment layer, the switchable optical layer can be configured to control light transmission and light scattering.

The secondary layer sections refer to the individual segments, respectively parts of the switchable optical layer that can be controlled independently. The partitioned layer can enable different sections to have varying levels of opacity. This can achieve the advantage of providing precise control over different areas of the window, enabling customized shading and light management.

The first optical state is the condition of the switchable optical layer, respectively a corresponding secondary layer section, when it is transparent, allowing maximum light transmission and unobstructed views. The second optical state with the switchable optical layer being partially opaque can reduce light transmission and/or obscure the view through the window. Herein, partially opaque can refer to a state where the switchable optical layer, respectively a corresponding secondary layer section, blocks some light, creating a light scattering and/or tinted surface appearance. Thereby, the switchable optical layer can be configured to diffuse light, reducing visibility.

Furthermore, the switchable optical layer can be configured to reduce glare in the second optical state.

Partially opaque can describe a material state where the material is not fully opaque but also not fully transparent, allowing some light to pass through while scattering and/or absorbing the rest. Such a state can be described as semi-opaque.

The controller can be configured to set the plurality of layer sections and the plurality secondary layer sections to a state of maximal light transmissivity when a power loss to the controller occurs. Thus, an unobstructed view through the complete window surface can be realized as a failsafe state. Thus, the transmissivity adjustment layer as well as the switchable optical layer can become completely transparent, in particular when no control via the controller is possible, and/or in a predefined emergency condition or safety condition of the vehicle.

In the event of a power loss, it is crucial that the window assembly defaults to a transparent state to ensure safety and visibility. Thereto, the window assembly can provide a clear-without-power-mechanism. This feature can guarantee that the window assembly remains unobstructed, providing a clear view even when the window assembly, respectively the controller is not powered. This failsafe mechanism is particularly beneficial in emergency situations, where maintaining visibility is essential for the safety of the vehicle's occupants. By ensuring that both the transmissivity adjustment layer and the switchable optical layer become transparent without power, the system enhances reliability and safety under all conditions.

The transmissivity adjustment layer can be configured to adjust to a completely transparent state in case no control signal is applied. Additionally or alternatively, the switchable optical layer can be configured to adjust to a completely transparent state in case no control signal, respectively no further control signal, is applied.

In a further embodiment, the transmissivity adjustment layer comprises an electrochromic medium. The electrochromic medium can be configured to appear colorless in a state of maximum light transmissivity. Further, the electrochromic medium can be configured to appear in a predetermined first color in any state with reduced light transmissivity.

The switchable optical layer can be configured to appear in a further color in the second optical state. The first color and the second color can be separated by at least one of the following criteria: a color difference measure of the first color and the second color exceeding a color similarity threshold value, and a brightness difference measure of the first color and the second color exceeding a brightness similarity threshold value.

The electrochromic medium can be disposed on a transparent surface, specifically a glass surface. Alternatively, the transmissivity adjustment layer can be disposed between two layers of transparent material. The transparent material can comprise glass and/or a polymer.

The transmissivity adjustment layer can comprise an electrochromic gel encapsulated between two panels. The electrochromic gel can darken or lighten in response to an electrical signal being applied to the gel. Preferably, a low-voltage current can be passed through conductive coatings to induce an electrochemical reaction in the gel such that the gel darkens. Removing electrical signal can allow the gel to return to its transparent state.

Adjusting a layer section can refer to a specific light transmissivity setting. Alternatively, adjusting can comprise a plurality of intermediate states such that the layer section fades continuously between an initial state and a final state, in particular with a predetermined progression rate. The progression rate can take a latency of the electrochromic material for a transmissivity change into account. Thereby a smooth transition can be achieved.

Preferably, the transmissivity adjustment layer can be configured to transition between a fully transparent state with maximum light transmissivity to a fully opaque state with minimum light transmissivity. The transmissivity adjustment layer can have a dark color, preferably black, in the fully opaque state.

Preferably, the switchable optical layer can be configured to transition between a fully transparent state with maximum light transmissivity to a fully opaque state in the predetermined color while a brightness level decreases according to the decreasing light transmissivity. The window assembly can comprise a tinted layer configured to provide a permanent tint to the window in any state of the transmissivity adjustment layer and/or of the switchable optical layer.

The switchable optical layer can have a light color, preferably white, in the fully opaque state. The switchable optical layer can have a predetermined color tone, i.e., hue. Thereby, the switchable optical layer can be adapted to match a color tone of surrounding elements of the window assembly, specifically a window bezel.

In a further embodiment, the transmissivity adjustment layer and the switchable optical layer can be operable to be controlled synchronously. A transmissivity change in a selected layer section can be initiated when a corresponding secondary layer section switches between the first optical state and the second optical state.

The transmissivity adjustment layer and the switchable optical layer, respectively the corresponding layer sections and secondary layer sections, can be controlled such that a state transition of the switchable optical layer, transitioning from a previous state to a differing target state as defined by the control signal, is perceivable as instantaneous.

The transmissivity adjustment layer may be controlled at the same time as the switchable optical layer, but the state transition may be perceived as having a lower transition speed than the transition of the switchable optical layer. Specifically adjusting a selected layer section may occur over a material dependent interval, wherein switching the corresponding secondary layer section occurs instantly. Thereto, a transition from the first optical state to the second optical state may mask the transition of the corresponding layer section of the transmissivity adjustment layer, and a further transition from the second optical state to the first optical state may render the transition of the corresponding section of the transmissivity adjustment layer visible.

Thus, depending on the state transition, the delayed transition of the transmissivity adjustment layer may not be perceivable or may be only partially perceivable as the transition of the switchable optical layer may mask the transition of the transmissivity adjustment layer.

Preferably, the directly perceivable switch between the first optical state and the second optical state may serve as an indicator that the window assembly responds to the corresponding control signal. A change in light transmissivity of the transmissivity adjustment layer may have a transition rate below a visibly perceivable threshold value. Thus, the substantially higher transition rate of the switchable optical layer can indicate a responsiveness of the window assembly to a control signal.

In a further embodiment, the controller can further be configured to control the transmissivity adjustment layer and the switchable optical layer synchronously, in particular by controlling each layer section changing from a first transmissivity state to a second transmissivity state in relation to a corresponding secondary layer section changing between the first optical state and the second optical state.

The controller can be configured to synchronously apply a control signal to a selected layer section and the corresponding secondary layer section such that when the secondary layer section switches between the first optical state and the second optical state a transmissivity change in the corresponding selected layer section is initiated. Thereby, a change in transmissivity of a section of the transmissivity adjustment layer can be visibly and instantaneously indicated by the corresponding section of the switchable optical layer.

The controller can be configured to control the secondary layer sections according to a manual input signal. Thereto, the controller can be configured to switch a corresponding secondary layer section within a predetermined latency interval with respect to the manual control input. Preferably, the predetermined latency interval is below a perceivable latency threshold value such that switching a corresponding secondary layer section is perceivable as instant in response to the manual input signal.

In a further embodiment, the window assembly can comprise a window bezel having a bezel color. The switchable optical layer can be disposed relatively closer to the window bezel than the transmissivity adjustment layer. Additionally, a color difference between the bezel color and the second color can be below a further color difference threshold value.

The window bezel can be a frame or border surrounding the window glass. The window bezel may provide structural support and/or aesthetic integration with the surrounding vehicle environment. The window bezel can be configured to mask electrical contacts to the window assembly, specifically to the plurality of layer sections and/or secondary layer sections.

The color difference threshold value can be a measure of the perceptible difference in color between two adjacent areas. It may define the maximum allowable difference in color to ensure visual consistency. A ΔE-(Delta E)-value can be used as a metric to quantify the color difference. By quantifying the difference between two colors, color consistency and accuracy can be ensured. Preferably, ΔE can be calculated within the CIE L*a*b* color space representing colors in a way that matches human perception. The ΔE value can provide a single numeric value representing the overall color difference between two samples. Lower ΔE values indicate greater color accuracy, while higher ΔE values indicate a significant mismatch. Preferably, ΔE ≤ 10 such that the colors are more similar than opposite. More preferably, ΔE ≤ 2 such that a color difference is perceptible at a glance. Even more preferably, ΔE ≤ 1 such that color difference is not perceptible by human eyes or at least only perceptible through close observation.

Matching the color of the window bezel and the color of the switchable optical layer in the second optical state can provide increased visual consistency and cohesiveness in design, and/or lower color, respectively brightness mismatches. Preferably, the window bezel and the switchable optical layer show colors perceivable as similar. Thereby an aesthetic effect can be achieved as the dark characteristic of the transmissivity adjustment layer in a low transmissivity state can be masked by the switchable optical layer which can appear in a similar color and/or brightness in reference to the window bezel. Preferably, the switchable optical layer in the second optical state can be perceivable as a light color, specifically a variant of white. In addition, the window bezel can be perceivable in a similarly light color.

The switchable optical layer may face the window bezel and may cover the transmissivity adjustment layer.

A glass stack of the window assembly comprising the transmissivity adjustment layer and the switchable optical layer can be disposed in relation to the window bezel such that the switchable optical layer is closer to the window bezel than the transmissivity adjustment layer.

The window bezel can be disposed on the glass stack such that the switchable optical layer can face towards the window bezel. This achieves the advantage that the switchable optical layer is visible over the transmissivity adjustment layer from passengers inside the vehicle.

Each of the secondary layer sections may show the second color in the second optical state.

In a further embodiment, the controller can further be configured to adjust the brightness value of the switchable optical layer by controlling the light transmissivity of the transmissivity adjustment layer.

The switchable optical layer can have a predetermined light transmissivity in the second optical state such that a brightness of the switchable optical layer can be adjusted by adjusting the light transmissivity of the transmissivity adjustment layer. Thus, light can at least partially pass through the transmissivity adjustment layer to realize a specific brightness to the switchable optical layer.

Thereby, the combination of transmissivity adjustment layer and switchable optical layer can provide the functionality of an adjustable brightness of the window assembly in reference to the interior of the vehicle. Thereto, the window assembly can act as a dimmable light source for the interior of the vehicle. In a further example a selected layer segment, respectively a selected combination of layer segments and corresponding secondary layer segments can be used as a light source. In other words, external light, in particular sunlight, entering through the window assembly can be dimmed and/or partly blocked to create variable lighting in the vehicle, specifically the passenger compartment. In an example, the window assembly can be set to a semi-opaque state comprising of a combination of second layer sections in the second optical state and corresponding layer sections having a predetermined transmissivity setting above the minimum transmissivity state.

Thereto, a secondary layer section can be configured to diffuse light transmitted through the corresponding section of the transmissivity adjustment layer. This can provide a localized light source with a specified brightness, respectively an adjustable brightness.

In a further embodiment, the controller can be configured to simultaneously adjust the transmissivity of a selected set of layer sections of the plurality of window sections.

Preferably, the set of layer sections can comprise all layer sections. Thereby, a complete dimming of the complete window assembly can be achieved, in particular without delays between sections.

Depending on the variable light conditions, the transmissivity adjustment layer can appear black. In combination with a polished, respectively sufficiently smooth surface, the window assembly can act as a reflective surface.

The switchable optical layer can be adjusted accordingly, i.e., for layer sections to be used as a mirror, the corresponding secondary layer sections can be in the first optical state, i.e., can be transparent.

In a further embodiment, each secondary layer section can be configured to scatter light in the second optical state.

This can achieve the advantage that that a mirror-line appearance, i.e., a mirror effect, of the window assembly can be minimized. Specifically, the transmissivity adjustment layer in a low transmissivity state can act as a mirror with the smooth inner window surface. Thereto, the switchable optical layer can minimize the reflectance of interior light inside the vehicle by the window assembly.

The switchable optical layer can be configured to provide a frosted glass effect in the second optical state. Preferably, the switchable optical layer can be designed to be light-diffusing still allowing light to pass through in the second optical state.

According to a second aspect the present disclosure relates to a window control system comprising a plurality of window assemblies. The controller can be configured to control the plurality of windows simultaneously to set a predetermined window appearance setting for all windows of the plurality of windows. The predetermined window appearance can comprise a predetermined state and/or predetermined state transition for each layer section and for each secondary layer section.

The window assemblies can be centrally controlled to achieve a homogenous light transmission or window perception state throughout the aerial vehicle. Thereto a central controller can be provided, configured to individually control each window assembly of the plurality of window assemblies. The central controller can be configured to execute predetermined lighting scenarios. For example, the centralized control can be configured to affect a simultaneous state change for all window assemblies. Thereby, a synchronized state transition in all window assemblies can be achieved.

### BRIEF DESCRIPTION OF THE DRAWINGS

The subject matter will hereinafter be described in conjunction with the following drawing figures, wherein like numerals denote like elements, and wherein:

FIG. 1 shows a schematic representation of the window assembly according to an embodiment;

FIG. 2 shows a schematic representation of a window assembly in different states during a transmissivity adjustment according to an embodiment;

FIG. 3 shows a further schematic representation of a window assembly in different states during a transmissivity adjustment according to a further embodiment;

FIG. 4 shows another schematic representation of a window assembly in different states during a transmissivity adjustment according to a further embodiment;

FIG. 5A shows a schematic sectional view of a window assembly according to an embodiment;

FIG. 5B shows a further schematic sectional view of a window assembly according to an embodiment; and

FIG. 6 shows a further schematic representation of the window assembly according to an embodiment.

### DETAILED DESCRIPTION

The following detailed description is merely exemplary in nature and is not intended to limit the disclosure herein and uses of the disclosure herein. Furthermore, there is no intention to be bound by any theory presented in the preceding background or the following detailed description.

The representations and illustrations in the drawings are schematic and not to scale. Like numerals denote like elements.

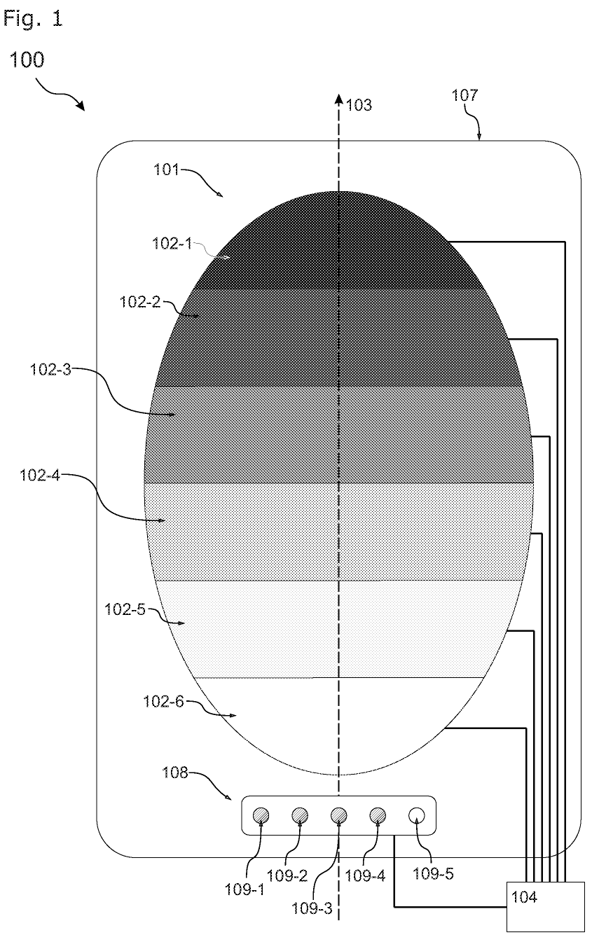

FIG. 1 shows a schematic representation of a window assembly 100 according to an embodiment. The window assembly 100 comprises a transmissivity adjustment layer 101 which is sectioned into six individual layer sections 102-1 to 102-6. The layer sections 102 are in different light transmissivity states. Specifically, a topmost layer section 102-1 can be in a minimal light transmissivity state. Thereto, the topmost layer section 102-1 can have completed a state transition from an initial state with a higher light transmissivity to a final state with lower light transmissivity. Each of the lower layer sections 102-2 to 102-6 may adjust to the same transmissivity state as the topmost layer section 102-1. Thereto, adjacent layer sections may initiate a transition to the final state of minimal light transmissivity one after the other with a delay. Thus, a visibly progressing gradient in light transmissivity can be generated. The gradient is indicated by different shades of grey of the layer sections 102-1 to 102-6.

In the shown example, the gradient progresses from a topmost layer section 102-1 to a bottommost section 102-6. A progression rate and gradient spacing can be varied by suitably adjusting a delay and/or amplitude of a control signal. The progression rate can be defined as a rate at which each layer segment 102 reaches its final state and at which state of a previous layer segment the next layer segment initiates its state transition. Similarly, the gradient spacing can be defined by a set number of segments being between the initial transmissivity state and the final transmissivity state.

The window assembly 100, specifically a material stack comprising the transmissivity adjustment layer 101 and at least a layer of transparent material acting as a substrate for the transmissivity adjustment layer 101 can have an oval shape. Thus, each layer section 102 can have a different surface area with respect to its adjacent layer sections when the layer sections have a constant width along the alignment axis 103. Alternatively, the width of the layer sections 102 can be defined such that each section has the same surface area. Thereby, the transition of each section blocks the same amount of light. This can yield a smooth brightness gradient even with a partially stepwise transition due to a finite number of layer sections 102.

The window assembly 100 can comprise a bezel 107 in which at least the transmissivity adjustment layer is framed.

An areal electrode atop and/or below each layer section may provide a homogenous transition of transmissivity. Thereto, the controller 104 can be electrically connected to the electrode and thereby the transmissivity adjustment layer 101 to provide the control signal. The controller can be individually connected to the layer sections.

The window assembly can comprise a control interface 108 configured to capture a manual input relating to an adjustment of the transmissivity adjustment layer 101 and/or the switchable optical layer 105. The control interface 108 can comprise a manual slider, a touch sensitive interface, e.g., capacitive or resistive, a light sensor, a light sensor array, etc. The control interface 108 can be configured to mimic a manual sliding control to adjust a setting of the transmissivity adjustment layer 101 and/or the switchable optical layer 105. Specifically, an increase or decrease of an area of high transmissivity of the transmissivity adjustment layer 101 and the simultaneous coverage by the switchable optical layer 105 can be controlled.

The control interface 108 can provide an intuitive and tactile experience, similar to operating a traditional window shade with the advantage of minimized movement and effort. The control interface can provide a direct control to a user to adjust the shading level by mimicking the physical movement of raising and lowering a shade.

A control direction of the control interface can be positioned in the direct vicinity of the window. Additionally, the control direction can be parallel or perpendicular to the alignment axis 103. The control interface 108 can be configured to provide a tactile response. The control interface can comprise visual markings indicating the state of the transmissivity adjustment layer 101 and/or the switchable optical layer 105, respectively the corresponding layer sections and secondary layer sections. Additionally, the control interface can comprise a transmissivity indicator configured to provide a visual indication of the current transmissivity state and/or a target transmissivity state. The transmissivity indicator can be configured to adjust according to the selected setting, respectively the provided manual input to reflect the selected state, respectively to indicate the state transition. Preferably, the transmissivity indicator can comprise a plurality of indicator elements 109-1 to 109-5 corresponding to the plurality of layer sections 102 and/or to the plurality of secondary layer sections. Thereto, each indicator element 109 can depict the status of the corresponding layer section 102 and/or secondary layer section in the shown example.

Thereto, the transmissivity indicator can comprise a light element configured to provide a light response according to a selected setting.

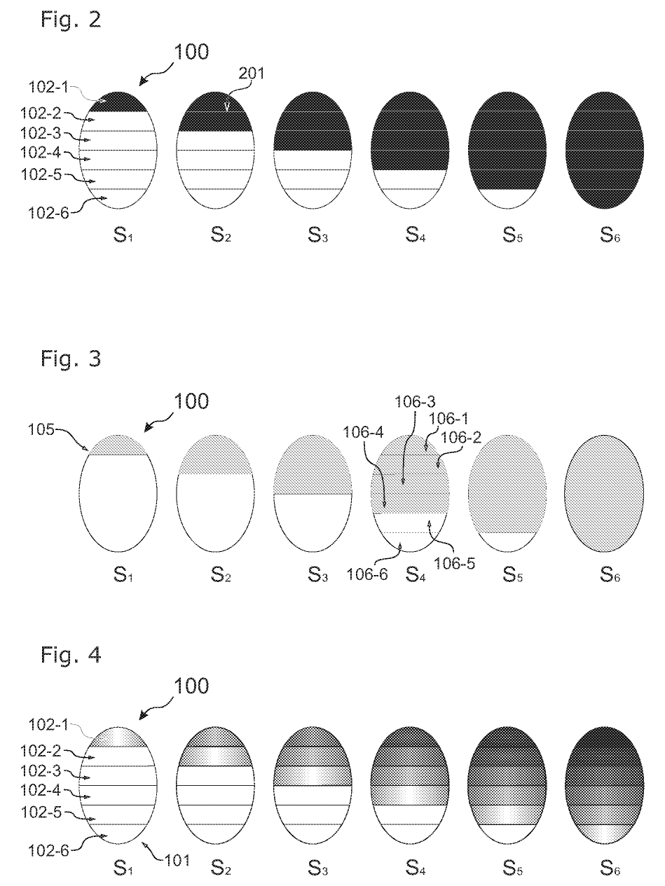

FIG. 2 shows a schematic representation of a window assembly 100 in different states S₁to S₆during a transmissivity adjustment according to an embodiment. Each subsequent state can be separated from the previous state by a predetermined time interval. Thereto a continuous movement of a border between a low transmissivity area and a high transmissivity area, i.e. a transparent area, can be realized. The window assembly 100 can be controlled to sequentially transition adjacent layer sections to the state of minimal light transmissivity. Thereto, a transition of the subsequent segment can be initiated once the previous layer section reaches a predetermined light transmissivity threshold value. Preferably, the previous section can reach a minimum light transmissivity before the subsequent layer section initiates its transition.

Layer boundaries 201 are exaggerated and may not be visible, imperceptible and/or inconsequential for the overall light transmissivity during use of the window assembly 100. Generally, the layer sections can be transitioned in any order and/or sequence depending on the requirements according to predetermined visual and/or transmissivity requirements. A layer boundary 201 between sections may be sufficiently wide to provide electrical and/or material separation between adjacent layer sections.

FIG. 3 shows a further schematic representation of a window assembly 100 at different times S₁ to S₆ during a transmissivity adjustment according to a further embodiment. The window assembly 100 comprises a switchable optical layer 105 layered on top of the transmissivity adjustment layer in reference to the depicted view of the window assembly, i.e., the view from an inside area of the vehicle facing outward. Thereto, the switchable optical layer 105, respectively secondary layer sections 106-1 to 106-6 may cover the layer sections of the transmissivity adjustment layer. For example, at S₄ the secondary layer sections 106-1 to 106-4 can be in the second optical state and cover the corresponding primary layer sections. The switchable optical layer 105 may exhibit a light color, preferably a variant of white, in the second optical state. Preferably, a secondary layer section 106 can mask the corresponding underlying layer section of the transmissivity adjustment layer, i.e., masking the dark color of the layer section due to the low light transmissivity when the corresponding secondary layer section 106 is in the second optical state. Masking can relate to a secondary layer section 106 of the switchable optical layer 105 covering at least part of the transmissivity adjustment layer, in particular a corresponding layer section for a passenger inside the vehicle.

Preferably, the secondary layer sections 106 are aligned with the underlying layer sections. The transmissivity adjustment layer and the switchable optical layer 105 can be integrated in a composite stack forming the window assembly 100. The layer sections can be disposed congruent to the secondary layer sections 106 such that the boundaries between layer sections align with boundaries of corresponding secondary layer sections. Increasing the number of secondary layer sections can mask a stepwise state change to create the illusion of a nearly continuous change along the alignment axis. Additionally or alternatively, each of the secondary layer sections 106 can be configured to gradually transition between the first optical state and the second optical state over a predetermined time interval.

FIG. 4 shows a further embodiment of the transmissivity adjustment layer according to an embodiment. A layer section can be configured to react inhomogenously to a control signal applied at the short edges of the layer section. Specifically, an electrochromic material disposed in a layer section can change its state in reference to a distance of a specific material section of the layer section to an electrode providing the control signal. Thus, during a state transition a layer section 102 may display a transmissivity gradient within the section, in particular until the final transmissivity state is reached.

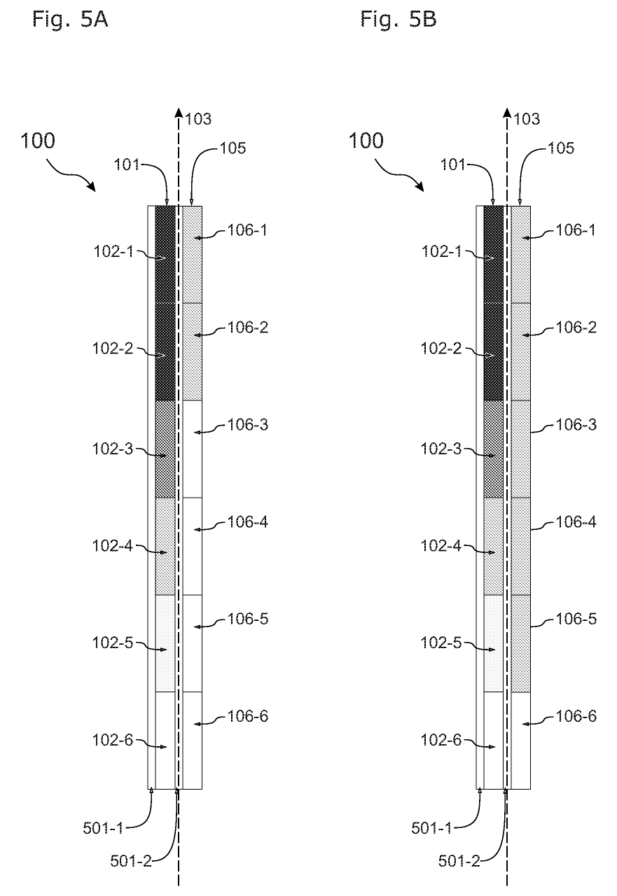

FIG. 5A shows a schematic sectional view of a window assembly 100 according to an embodiment. The transmissivity adjustment layer 101 can be sandwiched between two transparent layers 501-1, 501-2. The transparent layers 501-1, 501-2 can preferably be permanently transparent, e.g., glass, composite or polymer layers. Further, the transparent layer 501-1 can have a different composition in relation to the further transparent layer 501-2. The transparent layer 501-1 and/or the further transparent layer 501-2 can be configured to provide an electrical contact to the transmissivity adjustment layer 101. Preferably, each of the transparent layers 501-1, 501-2 comprises a plurality of surface electrodes wherein each electrode is aligned with a corresponding layer section 102 to provide a control signal to the respective layer section 102.

In the depicted state, the window assembly 100 can be in a transition of increasing transmissivity in an upward direction with reference to the alignment axis 103. For example, the secondary layer section 106-4 and subsequently the further secondary layer section 106-3 may have previously been in the second optical state. These secondary layer sections 106-3, 106-4 have completely transitioned to the first optical state. The corresponding primary layer sections 102-3 and 102-4 may have received a corresponding control signal to switch from a low transmissivity state to a high transmissivity state. Due to a material delay of adjusting from low transmissivity to high transmissivity, the primary layer sections may be visible during at least part of their respective state transition. Secondary layer sections 106-3 to 106-6 can be in a fully transparent state, i.e. the first optical state. Also, the primary layer sections 102-5 and 102-6 can be in a transparent state, i.e., a state of maximum transmissivity. The material stack comprising the transmissivity adjustment layer 101, the switchable optical layer 105 and the transparent layers 501-1 and 501-2 can comprise further layers. In particular a protective layer can be disposed on top of the switchable optical layer 105.

FIG. 5B shows a further schematic sectional view of a window assembly 100 according to an embodiment. In the depicted state, the window assembly 100 can be in a transition of decreasing transmissivity in a downward direction with reference to the alignment axis 103.

Thereto, the secondary layer sections 106-1 to 106-5 may have subsequently transitioned from the first optical state to the second optical state in a sequence according to a further control signal. Similarly, the layer sections 102-1 to 102-5 are controlled to adjust from a state of low transmissivity to a state of high transmissivity. Layer sections 102-1 and 102-2 may have completed this transition in the depicted state. Due to the variable light transmission through the primary layer sections 102-1 to 102-4, the secondary layer sections 106-1 to 106-4 may appear with a correspondingly varying brightness, i.e., an increasing brightness in the downward direction with reference to the alignment axis 103.

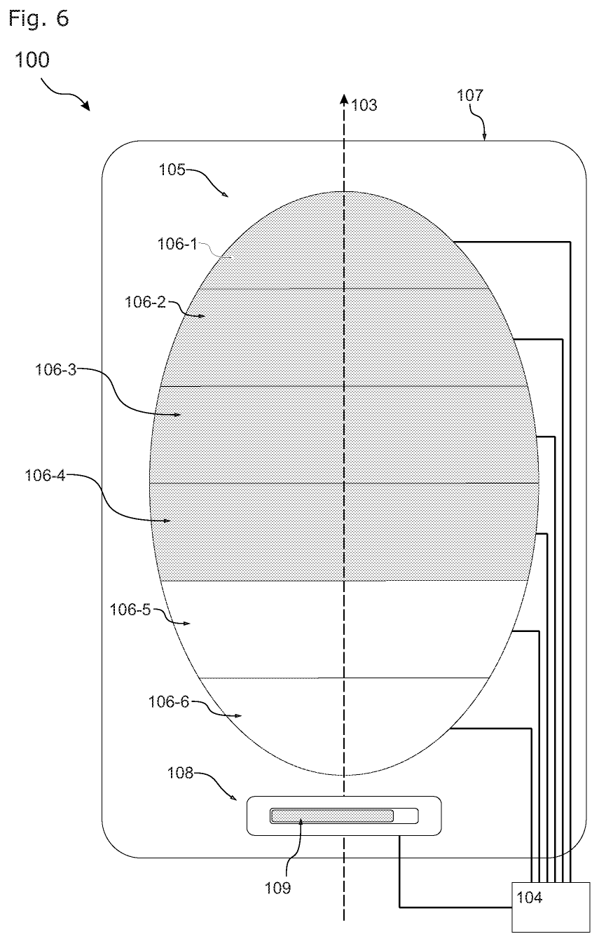

FIG. 6 shows a further schematic representation of the window assembly 100 according to an embodiment. The control interface 108 can provide a continuously adjustable range, e.g. a continuous slider. The controller 104 can be configured to map the selected setting to a corresponding setting for each layer section and secondary layer section 106. Thereto, the controller 104 can be configured to adjust the transmissivity of a layer section continuously between settings that correspond to actual layer section boundaries. For example, a setting in between two section boundaries can result in a proportional increase or decrease in transmissivity depending on how close the setting is to an adjacent layer section of minimal transmissivity or to an adjacent layer section of maximal transmissivity. Similarly, the controller 104 can be configured to switch the corresponding secondary layer section from the first optical state to the second optical state based on the selected setting. For example, the second optical state can be set depending on the direction of the adjustment and passing a midway point representing the mid adjustment point between to section boundaries of two adjacent secondary layer sections 106. The control interface can comprise a single continuous indicator element 109 configured to indicate a shading state and preferably a set position between secondary layer sections 106-5, 106-6 in the first optical state and secondary layer sections 106-1 to 106-4 in the second optical state. Preferably, the indicator element 109 can be overlayed over a continuous input segment of the control interface 108. For example, the indicator can follow a manual input.

Another embodiment of the window assembly (not shown) can comprise the following features: The control interface can comprise a clear state control element which can be configured to receive a manual input. The controller can be configured to set the window assembly to a clear state when the clear state control element is activated, i.e. receives the manual input. The clear state can be defined by the transmissivity adjustment layer adjusting to maximum light transmissivity and/or the switchable optical layer switching to the first optical state, i.e. a transparent state. The control interface can then be integrated in a separate opaque section of the window assembly. Additionally or alternatively, the separate opaque section can be integrated in the window bezel. The separate opaque section can be located adjacent to a bottom layer section of the transmissivity adjustment layer respectively a bottom layer section of the switchable optical layer.

The control interface can comprise a dark state control element which can be configured to receive a manual input. The controller can be configured to set the window assembly to a dark state when the dark state control element is activated, i.e., receives a manual input. The dark state can be defined by the transmissivity adjustment layer adjusting to a minimum transmissivity and/or the switchable optical layer switching to the second optical state, i.e., a light scattering state.

The indicator element can be segmented into a plurality of indicator segments. Each indicator segment can preferably be coupled with a corresponding manual input surface, e.g., a touch sensitive layer. Thereby, sliding a finger over the plurality of indicator elements can serve as an input to a specific shading setting, i.e. transmissivity setting. The plurality of indicator segments can be configured to visually indicate the selected state according to the captured manual input, e.g. touch input via the manual input surface. The indicator segments can be configured to show an initial setting, respectively past state, of the window assembly and/or a selected setting, i.e., a future state, of the window assembly. Furthermore, the indicator segments can be configured to display an animated transition between the initial setting and the selected setting. Thus, the indicator segments can mimic the transmissivity adjustment of the transmissivity adjustment layer, respectively the switching of the switchable optical layer by emitting a corresponding light signal and/or show a corresponding color and brightness. The control interface can be configured to receive a singular tapping input to any indicator segment, respectively the corresponding manual input surface section, as a user input. Preferably, the control interface is a capacitive touch interface.

In the claims, the word “comprising” does not exclude other elements or steps, and the indefinite article “a” or “an” does not exclude a plurality. A single processor or other unit may fulfil the functions of several items re-cited in the claims. The mere fact that certain measures are recited in mutually different dependent claims does not indicate that a combination of these measures cannot be used to advantage. Any reference signs in the claims should not be construed as limiting the scope.

While at least one example embodiment of the invention(s) is disclosed herein, it should be understood that modifications, substitutions, and alternatives may be apparent to one of ordinary skill in the art and can be made without departing from the scope of this disclosure. This disclosure is intended to cover any adaptations or variations of the example embodiment(s). Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A window assembly for sectional variable light transmission in an aerial vehicle, comprising:
a transmissivity adjustment layer sectioned into a plurality of layer sections which are adjacent to one another, and along an alignment axis, and wherein each layer section is individually operable to adjust a light transmissivity of the layer section according to a control signal applied to the layer section; and
a controller configured to sequentially apply an individual control signal to each layer section to generate a stepwise light transmissivity adjustment of the window assembly along the alignment axis.

2. The window assembly according to claim 1, wherein the controller is configured to apply a timed sequence of control signals to the transmissivity adjustment layer, wherein a delay is applied between control signals to adjacent layer sections.

3. The window assembly according to claim 2, wherein the controller is configured to set the delay to a value below a response latency of a corresponding layer section to reach the light transmissivity value set by the control signal.

4. The window assembly according to claim 1, wherein the controller is configured to set all layer sections to a state of maximal light transmissivity when a power loss to the controller occurs.

5. The window assembly according to claim 1, wherein each layer section has a constant width with respect to the alignment axis, and wherein a visible surface area in an assembled state of the window assembly is fully covered by the plurality of layer sections.

6. The window assembly according to claim 1, wherein the controller is configured to continuously adjust the light transmissivity of a layer section by providing at least one of:
a constant control signal,
a varying control signal,
to a corresponding layer section.

7. The window assembly according to claim 1, comprising a switchable optical layer sectioned into a plurality of secondary layer sections that are adjacent to one another and along the alignment axis, wherein each secondary layer section is operable to switch between a first optical state and a second optical state according to a further control signal,
wherein each secondary layer section is transparent in the first optical state, and
wherein each secondary layer section is at least partially opaque in the second optical state.

8. The window assembly according to claim 7, wherein the transmissivity adjustment layer comprises an electrochromic medium configured to:
appear colorless in a state of maximum light transmissivity;
appear in a predetermined first color in any state with reduced light transmissivity;
wherein the switchable optical layer is configured to appear in a further color in the second optical state, and
wherein the first color and the second color are separated by at least one of the following criteria:
a color difference measure of the first color and the second color exceeding a color similarity threshold value; and
a brightness difference measure of the first color and the second color exceeding a brightness similarity threshold value.

9. The window assembly according to claim 7, wherein the transmissivity adjustment layer and the switchable optical layer are operable to be controlled synchronously, wherein a transmissivity change in a selected layer section is initiated when a corresponding secondary layer section switches between the first optical state and the second optical state.

10. The window assembly according to claim 2,
comprising a switchable optical layer sectioned into a plurality of secondary layer sections that are adjacent to one another and along the alignment axis, wherein each secondary layer section is operable to switch between a first optical state and a second optical state according to a further control signal,
wherein each secondary layer section is transparent in the first optical state, and
wherein each secondary layer section is at least partially opaque in the second optical state
wherein the controller is further configured to control the transmissivity adjustment layer and the switchable optical layer synchronously by controlling each layer section changing from a first transmissivity state to a second transmissivity state in relation to a corresponding secondary layer section changing between the first optical state and the second optical state.

11. The window assembly according to claim 7, comprising a window bezel having a bezel color,
wherein the switchable optical layer is disposed relatively closer to the window bezel than the transmissivity adjustment layer, and
wherein a color difference between the bezel color and the second color is below a further color difference threshold value.

12. The window assembly according to claim 11, wherein the controller is further configured to adjust a brightness value of the switchable optical layer by controlling the light transmissivity of the transmissivity adjustment layer.

13. The window assembly according to claim 1, wherein the controller is configured to simultaneously adjust the transmissivity of a selected set of layer sections of the plurality of window sections.

14. The window assembly according to claim 7, wherein each secondary layer section is configured to scatter light in the second optical state.

15. A window control system comprising a plurality of the window assembly according to claim 1,
wherein the controller is configured to control the plurality of windows simultaneously to set a predetermined window appearance setting for all window assemblies of the plurality of window assemblies,
wherein the predetermined window appearance comprises at least one of a predetermined state and a predetermined state transition for each layer section and for each secondary layer section.
